(19) United States
(12) Patent Application Publication
(10) Pub. No.: US 2026/0100936 A1
(43) Pub. Date: Apr. 9, 2026

(54) APPLICATION MIGRATION SECURITY FRAMEWORK USING SERVICE MESH AND BI-DIRECTIONAL PROXY

(71) Applicant: Dell Products L.P., Round Rock, TX (US)

(72) Inventors: Parminder Singh Sethi, Ludhiana (IN); Anay Kishore, Bangalore (IN); Praveen Kumar, Noida (IN)

(73) Assignee: Dell Products L.P., Round Rock, TX (US)

(21) Appl. No.: 18/908,957

(22) Filed: Oct. 8, 2024

(51) Int. Cl. H04L 9/40

(52) U.S. Cl. CPC H04L 63/029

(57) ABSTRACT

Systems and methods for secure migration of applications using service mesh and bi-directional proxy are described. According to one embodiment, an Information Handling System (IHS) includes executable logic to receive a request to migrate an application from a first computing device to a second computing device, deploy a first side-car module on the first computing device and a second side-car module on the second computing device, establish a secure communication tunnel with the first and second side-car modules, and using the secure tunnel, migrate the application from the first computing device to the second computing device.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

IHSs may be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

Many computer processing architectures have recently migrated toward cloud computing. Cloud computing generally involves the delivery of computing services (e.g., applications) over the Internet. Whereas on-premises computing solutions can refer to in-house hosted software (e.g., on local servers, private clouds, etc.) that may be supported by a third party vendor or provider, cloud computing solutions may refer to software that is hosted and maintained by the same vendor. With cloud computing, a virtualized pool of resources, from raw compute power at the infrastructure level to application functionality, is often made available to a client, on demand, by a provider. One particular advantage of cloud computing is the ability to apply abstracted versions of compute, storage, and network resources to workloads, as needed, and tap into an abundance of prebuilt services. Cloud computing may enable users to tap into additional capabilities without requiring the investment of the infrastructure, such as new hardware or software. Rather, users often pay the provider of the cloud service a subscription fee or in cases lease the infrastructure that they use.

With the availability and utilization of virtualization technologies, computing environments may be used that accommodate deployment of applications in a variety of virtual infrastructure ranging environments from a private data center to a public computing cloud. Such applications and/or their corresponding data may be migrated (e.g., moved) between computing environments. For example, applications and their associated data may be migrated between private data centers and public computing clouds. Such migration may result in cost savings, availability of new services, decreased maintenance, and enhanced computational resource allocation.

### SUMMARY

Systems and methods for secure migration of applications using service mesh and bi-directional proxy are described. According to one embodiment, an Information Handling System (IHS) includes executable logic to receive a request to migrate an application from a first computing device to a second computing device, deploy a first side-car module on the first computing device and a second side-car module on the second computing device, establish a secure communication tunnel with the first and second side-car modules, and using the secure tunnel, migrate the application from the first computing device to the second computing device.

According to another embodiment, a secure application migration method includes the steps of receiving a request to migrate an application from a first of a plurality of computing devices to a second of the computing devices, deploying a first side-car module on the first computing device and a second side-car module on the second computing device, establishing a secure communication tunnel with the first and second side-car module, and using the secure tunnel, migrating the application from the first computing device to the second computing device.

According to yet another embodiment, a computer program product with a non-transitory computer readable storage medium has program instructions stored thereon that, upon execution by an Information Handling System (IHS), causes the IHS to receive a request to migrate an application from a first of a plurality of computing devices to a second of the computing devices, deploy a first side-car module on the first computing device and a second side-car module on the second computing device, establish a secure communication tunnel with the first and second side-car modules, and using the secure tunnel, migrate the application from the first computing device to the second computing device.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 illustrates an example secure application migration system that may provide a solution to the aforementioned problems, among others, with conventional application migration techniques according to one embodiment of the present disclosure.

FIG. 2 is a block diagram of components of an IHS, of which one or more may be used to implement embodiments of the secure application migration system of FIG. 1.

FIG. 3 illustrates several components of the smart migration utility and side-car modules that may be used to implement the secure application migration system according to one embodiment of the present disclosure.

FIG. 4 illustrates an example secure application migration method that may be performed by the secure application migration system to orchestrate the migration of an application from a computing device to a computing device according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

High availability of applications in a production environment is often a key factor for the success of any business. In current business scenarios, most of the applications and services have at least some form of a digital footprint. Many businesses are now dependent on technology in some manner. There are several technological solutions that help to provide the high availability of applications. Such solutions monitor system resources and when there is an increase in load or resource utilization, the migration of an application may be triggered, either manually or automatically. The migration of an application can be triggered due to several reasons. For example, an application’s migration can be triggered because of excessive resource loading due to reasons such as excessive business scaling or even due to illicit vandalism. When an application is migrated, it may need extra layers of protection due to increased level of attack vectors that may arise as the application is being migrated.

Analysis of challenges for the safe migration of applications can be an important aspect of the continuity of business processes as each application migration could involve different types of business applications and/or data in which each involves varying levels of complexities and priorities. Application migrations performed without proper planning and management often pose a greater threat of data loss, corruption, and security issues. Such issues can have significant monetary and trust losses and can also have detrimental impacts with respect to compliance and performance.

Maintaining a sufficient level of security during any type of migration can be challenging. Thus, it would be important to process and understand different types of parameters that may be important at different levels and/or stages of an application’s migration. Certain tests should be performed prior to starting the migration, such as during the migration trigger request stage. Examples of such tests may include validation and identification of the current computing device (e.g., source computing device) where the application is running on, encryption used on the current computing device, TLS level, security keys used, and basic indicators of attack (e.g., DoS, CSS. Etc.). Tests that may be performed during migration initiation may include flow control, session management, read/write locks used, and the like. Tests that may be performed during migration completion may include file size validation, count validation, integrity validation, and invalid request handling. Tests that may be performed during post migration validation may include session closure tests, read/write lock management tests, and ensuring temporary files and memory have been cleared. It may also be useful to implement a self-learning machine learning (ML) model to collect data from such migrations to understand any underlying challenges that may exist. Such learned information can help in making the overall process of ensuing migration operations more robust.

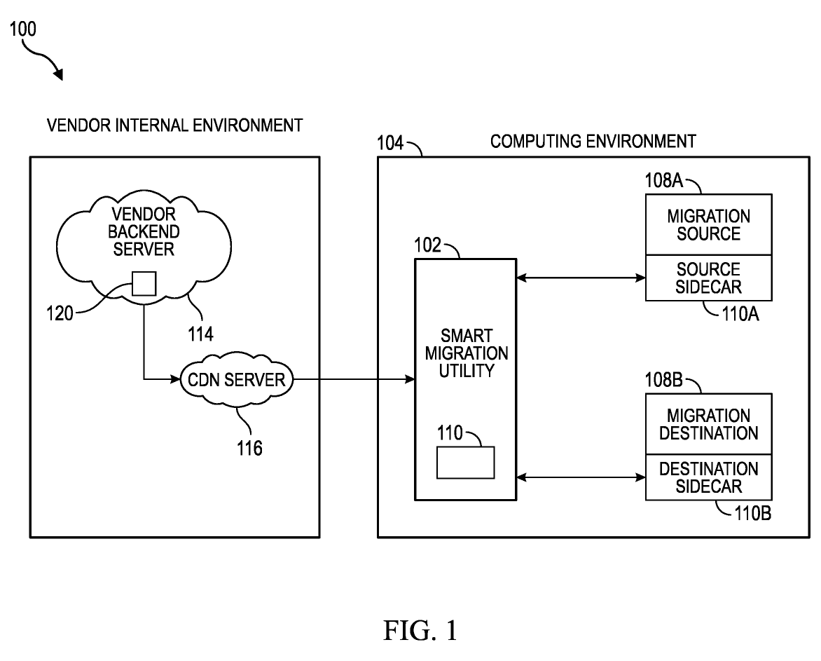

FIG. 1 illustrates an example secure application migration system 100 that may provide a solution to the aforementioned problems, among others, with conventional application migration techniques according to one embodiment of the present disclosure. The secure application migration system 100 includes a smart migration utility 102, which is an edge Computing based component that is stored locally (e.g., on premises) within a computing environment 104 of a user, such as an enterprise customer. The computing environment can be any type, such as a private data center or a public computing cloud. In some embodiments, the smart migration utility 102 can be stored in and accessed from a cloud hosted platform.

The smart migration utility 102 facilitates the migration of an application 106 from a source computing device 108a to a destination computing device 108b. The smart migration utility 102 stores a side-car module 110 that when a migration of the application 106 is initiated, deploys a copy source side-car module 110a on the source computing device 108a and a copy destination side-car module 110b on the destination computing device 108b.

The smart migration utility 102 remains resident within the computing environment 104 and is coupled to a vendor backend server 114 through a content delivery network (CDN) server 116 of a vendor computing environment 118 based on an edge computing model. The vendor computing environment 118 may be, for example, a vendor that manufactures or otherwise provides the computing devices 108a-b (collectively 108) for use by a user (e.g., customer) of the computing environment 104.

The smart migration utility 102 may communicate with the vendor backend server 114 to continually keep its version of firmware as well as that of the side-car module 110 updated with the latest version of software at ongoing intervals (e.g., once a week, once a month, whenever a new update is available, etc.). During migration of the application 106, the smart migration utility 102 monitors data movement between the source computing device 108a and the destination computing device 108b using a built-in bi-directional proxy to ensure that only valid communications are allowed to the source and destination side-car modules 110a-b (collectively 110). In one embodiment, the smart migration utility 102 may collect and send logs and usage data to the vendor backend server 114 for predictive analysis. That is, the vendor backend server 114 may include a machine learning (ML) process 120 that processes usage data from previous migrations to infer features that may be used to improve future application migration processes.

The smart migration utility 102 may function as a built-in bi-directional proxy for actively validating the migration transactions and filter out any unwanted transaction requests. Since many data center applications are configured with a single line of defense in form of firewall, adding the smart migration utility 102 as a node (e.g., a hop) in the network traffic may increase the level of security during active migrations.

In one embodiment, the smart migration utility 102 may ensure a relatively good degree of security during migration transactions using a secure key logic technique. This secure key will be generated during first stage of migration. Only transaction requests that carry the security key will be allowed to pass. In another embodiment, the smart migration utility 102 is only configurable with administrator (e.g., root) level access.

In one embodiment, the smart migration utility 102 includes an on-demand trigger feature that may be used by an external source (e.g., the application 106, the computing device 108, a user, etc.) to trigger a migration of the application 106. For example, when a computing device 108a determines that a processor loading threshold has been exceeded, it may communicate with the smart migration utility 102 to trigger a migration process to move the application 106 to another computing device 108b. The side-car deployment and on-demand trigger feature may be configured with a multi-threading concept to be able to spawn new instances of monitoring threads based on the number of migrations being monitored. Following completion of the migration, these threads will be killed, and the side-car modules 110 removed to save system resources.

In some aspects, the side-car module 110 may be considered to be an application that is based on a ‘Service Mesh’ concept. It will be stored as a deployable component in the smart migration utility 102 and will be pushed and deployed as a side-car module 110 at both end points associated with the application’s migration. The side-car module 110 establishes a secure connection tunnel for use during the application’s migration and close it upon completion of the migration. Additionally, each side-car module 110 may collect data on migration end points (e.g., computing devices 108a-b) and perform testing as described herein above. Essentially, the side-car module 110 keeps a vigil during migration and post migration validations to ensure the migration remains secure. Additionally, the communication between the smart migration utility 102 and each sidecar module 110 will be based on a secure key logic process to ensure higher level of security, which will be described in detail herein below.

The secure migration utility 102 in conjunction with the side-car modules 110 is based on the concepts of Edge Computing and Service Mesh architectures. The solution involves multiple types of validations throughout the multiple stages of migration. Migration may be considered to involve four stages of migration, namely: i) a migration trigger request stage, ii) a migration initiation stage, iii) a migration completion stage, and iv) a post migration validation stage. In some cases, the solution may include security enhancements that can be applied to or combined with existing migration methodologies to produce a safe and enhanced framework for different types of migrations.

Embodiments of the present disclosure may provide certain advantages over conventional application migration techniques. For example, the secure application migration system and method may provide a secure migration framework to alleviate or reduce data center application attacks during migration of an enterprise application running as part an edge environment by using a bi-directional proxy in which a light-weight side-car may be automatically deployed using a service mesh architecture. Additionally, the secure application migration system and method may generate a fresh secure key on-the-fly for each migration process to secure the end-to-end migration process as opposed to any hard-coded key or logic, which can make the application be vulnerable to attack. This secure key will be included with both side-cars (e.g., both source & destination end points) to make service message communication safe and secure. The secure application migration system and method may also provide a validation framework that would execute in each side-car as well as the smart migration utility (SMU) to continually monitor the data being migrated and its security across the ecosystem when the data flows from its source to destination.

According to embodiments of the present disclosure, an IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

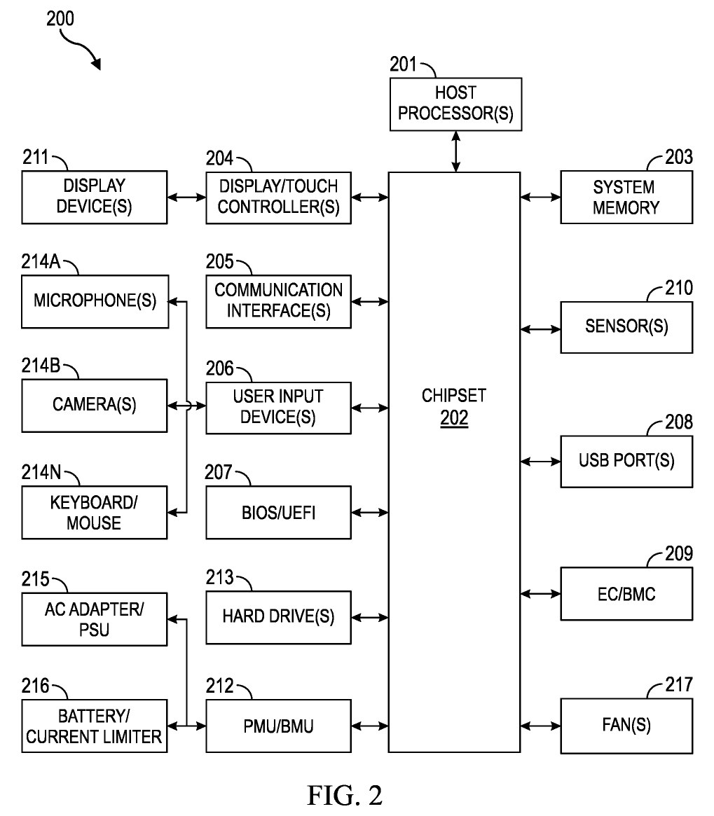

FIG. 2 is a block diagram of components of an IHS 200, of which one or more may be used to implement embodiments of the secure application migration system 100 of FIG. 1. For example, IHS 200 may be used to implement the computing devices 108a-b of FIG. 1. As depicted, IHS 200 includes host processor(s) 201. In various embodiments, IHS 200 may be a single-processor system, a multi-processor system including two or more processors, and/or a heterogeneous computing platform. Host processor(s) 201 may include any processor capable of executing program instructions, such as a PENTIUM processor, or any general-purpose or embedded processor implementing any of a variety of Instruction Set Architectures (ISAs), such as an x86 or a Reduced Instruction Set Computer (RISC) ISA (e.g., POWERPC, ARM, SPARC, MIPS, etc.).

IHS 200 includes chipset 202 coupled to host processor(s) 201. Chipset 202 may provide host processor(s) 201 with access to several resources. In some cases, chipset 202 may utilize a QuickPath Interconnect (QPI) bus to communicate with host processor(s) 201.

Chipset 202 may also be coupled to communication interface(s) 205 to enable communications between IHS 200 and various wired and/or wireless networks, such as Ethernet, WiFi, BLUETOOTH (BT), cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 205 may also be used to communicate with certain peripherals devices (e.g., BT speakers, microphones, headsets, etc.). Moreover, communication interface(s) 205 may be coupled to chipset 202 via a Peripheral Component Interconnect Express (PCIe) bus, or the like.

Chipset 202 may be coupled to display/touch controller(s) 204, which may include one or more Graphics Processor Units (GPUs) on a graphics bus, such as an Accelerated Graphics Port (AGP) or PCIe bus. As shown, display/touch controller(s) 204 provide video or display signals to one or more display device(s) 211.

Display device(s) 211 may include Liquid Crystal Display (LCD), Light Emitting Diode (LED), organic LED (OLED), or other thin film display technologies. Display device(s) 211 may include a plurality of pixels arranged in a matrix, configured to display visual information, such as text, two-dimensional images, video, three-dimensional images, etc. In some cases, display device(s) 211 may be provided as a single continuous display, or as two or more discrete displays.

Chipset 202 may provide host processor(s) 201 and/or display/touch controller(s) 204 with access to system memory 203. In various embodiments, system memory 203 may be implemented using any suitable memory technology, such as static RAM (SRAM), dynamic RAM (DRAM) or magnetic disks, or any nonvolatile/Flash-type memory, such as a solid-state drive (SSD) or the like.

Chipset 202 may also provide host processor(s) 201 with access to one or more Universal Serial Bus (USB) ports 208, to which one or more peripheral devices may be coupled (e.g., integrated or external webcams, microphones, speakers, etc.).

Chipset 202 may further provide host processor(s) 201 with access to one or more hard disk drives, solid-state drives, optical drives, or other removable-media drives 213.

Chipset 202 may also provide access to one or more user input devices 206, for example, using a super I/O controller or the like. Examples of user input devices 206 may include, but are not limited to, microphone(s) 214A, camera(s) 214B, and keyboard/mouse 214N. Other user input devices 206 may include a touchpad, trackpad, stylus or active pen, totem, etc.

Each user input devices 206 may include a respective controller (e.g., a touchpad may have its own touchpad controller) that interfaces with chipset 202 through a wired or wireless connection (e.g., via communication interfaces(s) 205). In some cases, chipset 202 may also provide access to one or more user output devices (e.g., video projectors, paper printers, 3D printers, loudspeakers, audio headsets, Virtual/Augmented Reality (VR/AR) devices, etc.). In certain embodiments, chipset 202 may further provide an interface for communications with hardware sensors 210.

Sensors 210 may be disposed on or within the chassis of IHS 200, or otherwise coupled to IHS 200, and may include, but are not limited to: electric, magnetic, radio, optical (e.g., camera, webcam, etc.), infrared, thermal (e.g., thermistors etc.), force, pressure, acoustic (e.g., microphone), ultrasonic, proximity, position, deformation, bending, direction, movement, velocity, rotation, gyroscope, Inertial Measurement Unit (IMU), and/or acceleration sensor(s).

The Unified Extensible Firmware Interface (UEFI) was designed as a successor to BIOS. As a result, many modern IHSs utilize UEFI in addition to or instead of a BIOS. As used herein, BIOS 207 is intended to also encompass a UEFI component.

Embedded Controller (EC) or Baseboard Management Controller (BMC) 209 is operational from the very start of each IHS power reset and handles various tasks not ordinarily handled by host processor(s) 201. Examples of these operations may include, but are not limited to: receiving and processing signals from a keyboard or touchpad, as well as other buttons and switches (e.g., power button, laptop lid switch, etc.), receiving and processing thermal measurements (e.g., performing fan control, CPU and GPU throttling, and emergency shutdown), controlling indicator LEDs (e.g., caps lock, scroll lock, number lock, battery, power, wireless LAN, sleep, etc.), managing PMU/BMU 212, alternating current (AC) adapter/Power Supply Unit (PSU) 215 and/or battery/current limiter 216, allowing remote diagnostics and remediation over network(s), etc. For example, EC/BMC 209 may implement operations for interfacing with power adapter/PSU 215 in managing power for IHS 200. Such operations may be performed to determine the power status of IHS 200, such as whether IHS 200 is operating from AC adapter/PSU 215 and/or battery 216.

Firmware instructions utilized by EC/BMC 209 may also be used to provide various core operations of IHS 200, such as power management and management of certain modes of IHS 200 (e.g., turbo modes, maximum operating clock frequencies of certain components, etc.). In addition, EC/BMC 209 may implement operations for detecting certain changes to the physical configuration or posture of IHS 200. For instance, when IHS 200 is embodied as a 2-in-1 laptop/tablet form factor, EC/BMC 209 may receive inputs from a lid position or hinge angle sensor 210, and it may use those inputs to determine: whether the two sides of IHS 200 have been latched together to a closed position or a tablet position, the magnitude of a hinge or lid angle, etc. In response to these changes, the EC may enable or disable certain features of IHS 200 (e.g., front or rear facing camera, etc.).

In some cases, EC/BMC 209 may be configured to identify any number of IHS postures, including, but not limited to: laptop, stand, tablet, tent, or book. For example, when display(s) 211 of IHS 200 is open with respect to a horizontal keyboard portion, and the keyboard is facing up, EC/BMC 209 may determine IHS 200 to be in a laptop posture. When display(s) 211 of IHS 200 is open with respect to the horizontal keyboard portion, but the keyboard is facing down (e.g., its keys are against the top surface of a table), EC/BMC 209 may determine IHS 200 to be in a stand posture.

When the back of display(s) 211 is closed against the back of the keyboard portion, EC/BMC 209 may determine IHS 200 to be in a tablet posture. When IHS 200 has two display(s) 211 open side-by-side, EC/BMC 209 may determine IHS 200 to be in a book posture. When IHS 200 has two displays open to form a triangular structure sitting on a horizontal surface, such that a hinge between the displays is at the top vertex of the triangle, EC/BMC 209 may determine IHS 200 to be in a tent posture. In some implementations, EC/BMC 209 may also determine if display(s) 211 of IHS 200 are in a landscape or portrait orientation. In some cases, EC/BMC 209 may be installed as a Trusted Execution Environment (TEE) component to the motherboard of IHS 200.

Additionally, or alternatively, EC/BMC 209 may be configured to calculate hashes or signatures that uniquely identify individual components of IHS 200. In such scenarios, EC/BMC 209 may calculate a hash value based on the configuration of a hardware and/or software component coupled to IHS 200. For instance, EC/BMC 209 may calculate a hash value based on all firmware and other code or settings stored in an onboard memory of a hardware component.

Hash values may be calculated as part of a trusted process of manufacturing IHS 200 and may be maintained in secure storage as a reference signature. EC/BMC 209 may later recalculate the hash value for a component, compare it against the reference hash value to determine if any modifications have been made to the component, thus indicating that the component has been compromised. In this manner, EC/BMC 209 may validate the integrity of hardware and software components installed in IHS 200.

In various embodiments, IHS 200 may be coupled to an external power source (e.g., AC outlet or mains) through an AC adapter/PSU 215. AC adapter/PSU 215 may include an adapter portion having a central unit (e.g., a power brick, wall charger, or the like) configured to draw power from an AC outlet via a first electrical cord, convert the AC power to direct current (DC) power, and provide DC power to IHS 200 via a second electrical cord.

Additionally, or alternatively, AC adapter/PSU 215 may include an internal or external power supply portion (e.g., a switching power supply, etc.) connected to the second electrical cord and configured to convert AC to DC. AC adapter/PSU 215 may also supply a standby voltage, so that most of IHS 200 can be powered off after preparing for hibernation or shutdown, and powered back on by an event (e.g., remotely via wake-on-LAN, etc.). In general, AC adapter/PSU 215 may have any specific power rating, measured in volts or watts, and any suitable connectors.

IHS 200 may also include internal or external battery 216. Battery 216 may include, for example, a Lithium-ion or Li-ion rechargeable device capable of storing energy sufficient to power IHS 200 for an amount of time, depending upon the IHS’s workloads, environmental conditions, etc. In some cases, a battery pack may also contain temperature sensors, voltage regulator circuits, voltage taps, and/or charge-state monitors. For example, battery 216 may include a current limiter, or the like.

In some embodiments, battery 216 may be configured to detect overcurrent or undervoltage conditions using Limits Management Hardware (LMH). As used herein, the term “overcurrent” refers to a condition in an electrical circuit that arises when a normal load current is exceeded (e.g., overloads, short circuits, etc.). Conversely, the term “undervoltage” refers to a condition (e.g., “brownout”) where the applied voltage drops to X% of rated voltage (e.g., 90%), or less, for a predetermined amount of time (e.g., 1 minute).

Power Management Unit (PMU) 212 governs power functions of IHS 200, including AC adapter/PSU 215 and battery 216. For example, PMU 212 may be configured to: monitor power connections and battery charges, charging batteries, control power to other components, devices, or ICs, shut down components when they are left idle, control sleep and power functions (On and Off), managing interfaces for built-in keypad and touchpads, regulate real-time clocks (RTCs), etc.

In some implementations, PMU 212 may include one or more Power Management Integrated Circuits (PMICs) configured to control the flow and direction or electrical power in IHS 200. Particularly, a PMIC may be configured to perform battery management, power source selection, voltage regulation, voltage supervision, undervoltage protection, power sequencing, and/or charging operations. It may also include a DC-to-DC converter to allow dynamic voltage scaling, or the like.

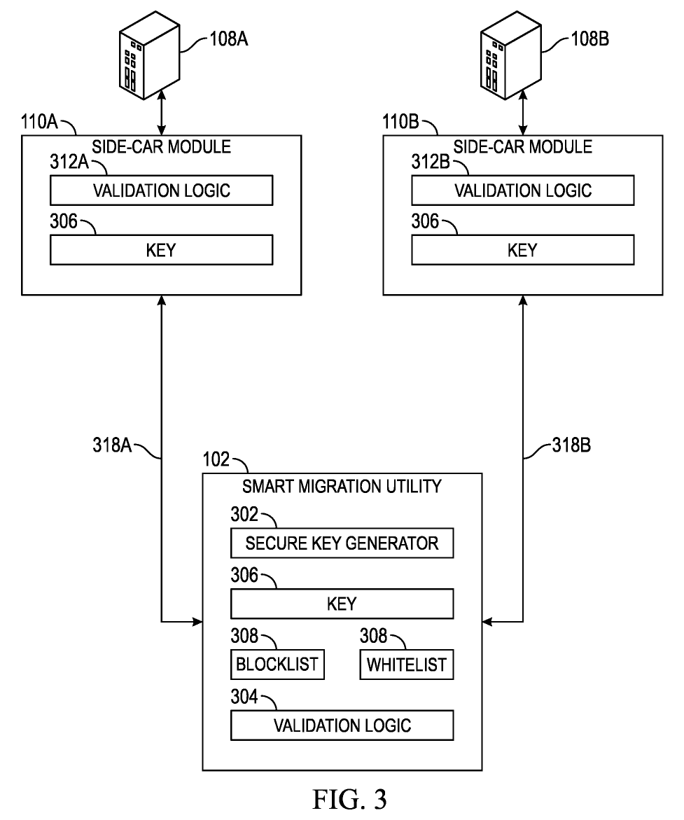

Additionally, or alternatively, PMU 212 may include a Battery Management Unit (BMU) (referred to collectively as “PMU/BMU 212”). AC adapter/PSU 215 may be removably coupled to a battery charge controller within PMU/BMU 212 to provide IHS 200 with a source of DC power from battery cells within battery 216 (e.g., a lithium ion (Li-ion) or nickel metal hydride (NiMH) battery pack including one or more rechargeable batteries). PMU/BMU 212 may include non-volatile memory and it may be configured to collect and store battery status, charging, and discharging information, and to provide that information to other IHS components, such as, for example devices within heterogeneous computing platform 300 (FIG. 3).

Examples of information collected and stored in a memory within PMU/BMU 212 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information (e.g., such as ambient temperature, relative humidity, system geolocation measured by GPS or triangulation, time and date, etc.), and BMU events.

Examples of BMU events may include, but are not limited to acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, power draw measurements may be conducted with control and monitoring of power supply via PMU/BMU 212. Power draw data may also be monitored with respect to individual components or devices of IHS 200. Whenever applicable, PMU/BMU 212 may administer the execution of a power policy, or the like.

IHS 200 may also include one or more fans 217 configured to cool down one or more components or devices of IHS 200 disposed inside a chassis, case, or housing. Fan(s) 217 may include any fan inside, or attached to, IHS 200 and used for active cooling. Fan(s) 217 may be used to draw cooler air into the case from the outside, expel warm air from inside, and/or move air across a heat sink to cool a particular IHS component. In various embodiments, both axial and sometimes centrifugal (blower/squirrel-cage) fans may be used.

In other embodiments, IHS 200 may not include all the components shown in FIG. 2. In other embodiments, IHS 200 may include other components in addition to those that are shown in FIG. 2. Furthermore, some components that are represented as separate components in FIG. 2 may instead be integrated with other components, such that all or a portion of the operations executed by the illustrated components may instead be executed by the integrated component.

For example, in various embodiments described herein, host processor(s) 201 and/or other components of IHS 200 (e.g., chipset 202, display/touch controller(s) 204, communication interface(s) 205, EC/BMC 209, etc.) may be replaced by discrete devices within a heterogeneous computing platform. As such, IHS 200 may assume different form factors including, but not limited to: servers, workstations, desktops, laptops, appliances, video game consoles, tablets, smartphones, etc.

FIG. 3 illustrates several components of the smart migration utility 102 and side-car modules 110a-b that may be used to implement the secure application migration system 100 according to one embodiment of the present disclosure. The smart migration utility 102 is configured with a secure key generator 302 and validation logic 304 that may be used to validate data being proxied through the smart migration utility 102. Each side-car module 110a-b includes its own validation logic 312a-b for validating data transmitted by and received from its respective computing device 108a-b.

Upon receiving an On-demand trigger request for a migration, the secure key generator 302 generates a secure key 306 that is unique to each migration process. In one embodiment, the secure key generator 302 may use a combination of I) a current timestamp converted to coordinated universal time (UTC), ii) a secure random alphanumeric key (e.g., using cryptographically secure programmable random number generator (PRNG) logic), and iii) an optional user provided key. Generating a secure key using a current timestamp may provide enhanced randomness by ensuring a different value is used each time. The secure key generator 302 may generate the secure key 306, deploy it in each side-car module 110a-b, and then deploy the side-car module 110a-b in its respective computing device 108a-b. All further communications between the sidecar modules 110a-b and smart migration utility 102 will use this secure key 306 to establish secure tunnels 318a-b. Fresh secure keys 306 will be generated every time a new migration has been triggered. All transactions or messages not having this secure key 306 will be rejected and the requesting source (e.g., the computing device or IHS that issued the transaction or message) will be marked in a block list 306 that is stored in the smart migration utility 102. In some embodiments, the smart migration utility 102 may be configured with a white list 310 that allows certain actions to be performed when conditions within he white list 310 are met.

As the risk of attack can be high during application migration, the validation logic 312a-b in each side-car module 110a-b will actively monitor several security parameters to alleviate or reduce any chances of attacks. Monitoring and migration using the side-car modules 110a-b will be done based on the concept of multi-threading, to be able to spawn new thread and process instances for efficient migration using proper read/write locks. Once the migration process is over, each validation logic 312a-b may run post migration validation to ensure that the migration has completed, such as performing integrity checks, verifying a count of files, closing of any open sessions, and the like. Each validation logic 312a-b may also clear any temporary files or memory used and send notifications to the smart migration utility 102 about a completion status of the migration. Following validation of migration, both of the participating instances of the side-car module 110a-b (e.g., migration source and migration destination) will be cleared off and the secure key generated for migration will also be marked appropriately, as a clean-up activity, once migration is done.

To protect against various types of attacks (e.g., denial-of-service (DoS) attacks, cross-site scripting (CSS) attacks, etc.) during an active migration, validation logic 312a-b in each side-car module 110a-b, and validation logic 304 in the smart migration utility 102 may process different calls coming towards the computing devices 108a-b participating in the migration. When data migration is in progress, one or more of the following parameters may be validated: i) if the request body has structural abnormalities, ii) if the specified encryption level is being followed or not, iii) whether certificates used in the application are up to date, iv) certificate issuing authority identified in client call, v) proper symmetric and/or asymmetric cryptography (as per application specification) being used, vi) proper transport layer security (TLS) version specification, vii) signs of stored procedures and/or structured query language (SQL) injections, viii) any known bad actor, and ix) the secure key generated by the smart migration utility 102. While several validation parameters are shown, it should be appreciated that is other embodiments, the secure application migration system 100 may include more parameters, fewer parameters, or different parameters than what is described herein. If any or certain of the aforedescribed parameters are not as per the application data specification in a particular call, that call should be rejected, and an entry made in the blacklist 308 of smart migration utility 102.

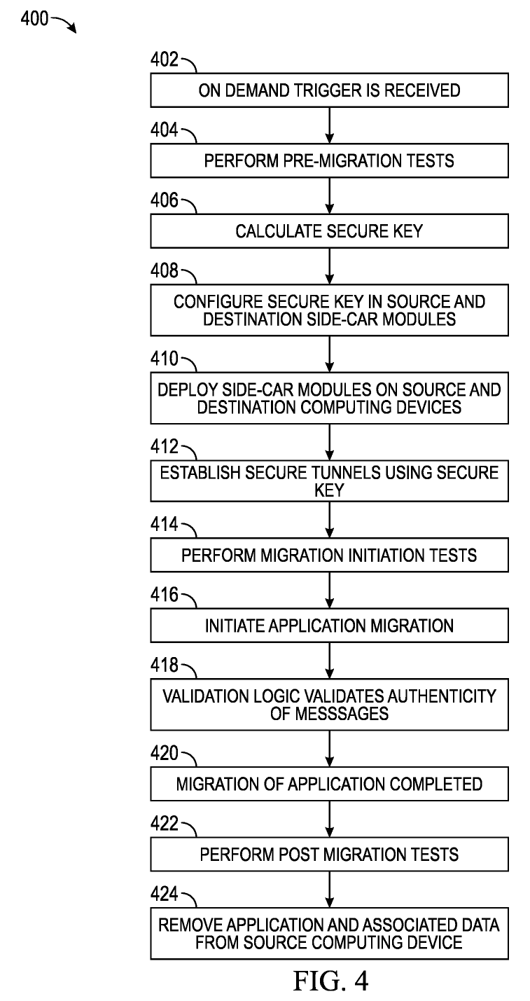

FIG. 4 illustrates an example secure application migration method 400 that may be performed by the secure application migration system 100 to orchestrate the migration of an application 106 from a computing device 108a to a computing device 108b according to one embodiment of the present disclosure. The method 400 may be performed each time that an application 106 is to be migrated. Additionally or alternatively, the secure application migration method 400 may be performed at least in part, by the smart migration utility 102 as described herein above with reference to FIG. 1. Initially, the smart migration utility 102 may be configured locally in a computing environment 104 within which an application 106 is to be migrated. In other embodiments, the secure application migration method 400 may be performed using a smart migration utility 102 that is stored externally to the computing environment 104 in a cloud-based platform.

At step 402, the method 400 receives an on demand trigger. The trigger may be received manually via user input, or automatically by a process (e.g., the application 106 to be migrated) running in the computing environment 104. At step 404, the method 400 performs one or more pre-migration tests. Examples of such tests may include validation and identification of the current computing device 108a (e.g., source platform) where the application 106 is running on, encryption used on the current computing device 108a, TLS level, security keys used, and basic indicators of attack (e.g., DoS, CSS. Etc.).

At step 406, the method 400 calculates a secure key 306 that is unique for a single migration. In one embodiment, the secure key 306 may be calculated using a current timestamp converted to UTC, a secure random alphanumeric key, an optional user provided key, or other suitable combination of parameters. The method 400 then configures the secure key 306 in the source and destination side-car modules 110a-b at step 408, and deploys side-car modules 110a-b on the source and destination computing devices 108a-b at step 410.

At step 412, the method 400 establishes secure tunnels 318a-b using the generated secure key 306. Two secure tunnels may be established; one tunnel 318a between the source computing device 108a and smart migration utility 102, and a second secure tunnel 318b between the smart migration utility 102 and destination computing device 108b such that the smart migration utility 102 functions as a bi-directional proxy. The method 400 may then perform one or more migration initiation tests at step 414. Examples of such tests may include flow control tests, session management tests, validation of read/write locks used, and the like. Thereafter at step 416, the method 400 initiates the application migration.

During the application 106 migration, the method 400 (e.g., validation logic 304 and validation logic 312a-b) continually validates the authenticity of messages transmitted through the secure tunnels at step 418. When the application 106 is fully migrated (e.g., copied) to the destination computing device 108b, the migration of the application 106 is completed at step 420. Thereafter at step 422, the method 400 performs one or more post migration tests. Examples of post migration tests may include session closure tests, read/write lock management tests, and ensuring temporary files and memory have been cleared. Once the tests have successfully completed, the method 400 may then remove the application 106 and its associated data from the source computing device 108a at step 424.

The steps of the aforedescribed process may be performed each time that an application 106 is to be migrated within the computing environment 104. Nevertheless, when use of the secure application migration method 400 is no longer needed or desired, the process ends.

Although FIG. 4 describes an example method 400 that may be performed to orchestrate the migration of multiple storage objects using mobility groups, the features of the method 400 may be embodied in other specific forms without deviating from the spirit and scope of the present disclosure. For example, the method 400 may perform additional, fewer, or different operations than those described in the present examples. For another example, the method 400 may be performed in a sequence of steps different from that described above. As yet another example, certain steps of the method 400 may be performed by other components than the multi-cloud management tool 102 described herein above.

In accordance with the foregoing, embodiments of the present systems and methods provide secure temporary privileged access to nodes in a cluster. To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. A secure application migration system comprising:
a computing environment comprising a plurality of computing devices; and
an Information Handling System (IHS) comprising at least one memory coupled to at least one processor, the at least one memory having program instructions stored thereon that, upon execution by the at least one processor, cause the IHS to:
receive a request to migrate an application from a first of the computing devices to a second of the computing devices;
deploy a first side-car module on the first computing device and a second side-car module on the second computing device;
establish a secure communication tunnel with the first and second side-car modules; and
using the secure tunnel, migrate the application from the first computing device to the second computing device.

2. The secure application migration system of claim 1, wherein the program instructions, upon execution, further cause the IHS to establish the secure tunnel, generate a secure key and send the generated secure key to first and second side-car modules.

3. The secure application migration system of claim 2, wherein the program instructions, upon execution, further cause IHS to generate the secure key using a current timestamp.

4. The secure application migration system of claim 2, wherein the program instructions, upon execution, further cause IHS to generate a new secure key each time the application is migrated.

5. The secure application migration system of claim 1, wherein each of the side-car modules comprise a second memory coupled to a second processor, the second memory has logic stored thereon that, upon execution by the at least one processor, cause each of the first and second side-car modules to validate data sent to and from its respective computing device.

6. The secure application migration system of claim 5, wherein the logic, upon execution, further cause IHS to validate the data by performing at least one of a flow control test, a session management test, or validation of read/write locks used.

7. The secure application migration system of claim 1, wherein the program instructions, upon execution, further cause IHS to, when the validation fails, add information associated with the failed source to a blacklist.

8. The secure application migration system of claim 1, wherein the program instructions comprise a utility that is statically stored in the computing environment.

9. The secure application migration system of claim 8, wherein the program instructions, upon execution, further cause IHS to continually update the program instruction at ongoing intervals.

10. The secure application migration system of claim 1, wherein the program instructions, upon execution, further cause IHS to send data associated with the migration to a machine learning (ML) process, wherein the ML process is configured to perform analytics on the data to learn how to improve ensuing migrations.

11. A secure application migration method comprising:
receiving a request to migrate an application from a first of a plurality of computing devices to a second of the computing devices, the computing devices configured in a computing environment;
deploying a first side-car module on the first computing device and a second side-car module on the second computing device;
establishing a secure communication tunnel with the first and second side-car module; and
using the secure tunnel, migrating the application from the first computing device to the second computing device.

12. The secure application migration method of claim 11, further comprising establishing the secure tunnel, generate a secure key and send the generated secure key to first and second side-car modules.

13. The secure application migration method of claim 12, further comprising generating the secure key using a current timestamp.

14. The secure application migration method of claim 12, further comprising generating a new secure key each time the application is migrated.

15. The secure application migration method of claim 14, further comprising continually updating the program instruction at ongoing intervals.

16. The secure application migration method of claim 11, further comprising sending data associated with the migration to a machine learning (ML) process, wherein the ML process performs analytics on the data to learn how to improve ensuing migrations.

17. A computer program product comprising a non-transitory computer readable storage medium having program instructions stored thereon that, upon execution by an Information Handling System (IHS), cause the IHS to:
receive a request to migrate an application from a first of a plurality of computing devices to a second of the computing devices, the computing devices configured in a computing environment;
deploy a first side-car module on the first computing device and a second side-car module on the second computing device;
establish a secure communication tunnel with the first and second side-car modules; and
using the secure tunnel, migrate the application from the first computing device to the second computing device.

18. The computer program product of claim 17, wherein the program instructions, upon execution, further cause IHS to establish the secure tunnel using a current timestamp, and generate a secure key and send the generated secure key to first and second side-car modules.

19. The computer program product of claim 18, wherein the program instructions, upon execution, further cause IHS to generate a new secure key each time the application is migrated.

20. The computer program product of claim 17, wherein the program instructions comprise a utility that is statically stored in the computing environment.
